(19) United States
(12) Patent Application Publication
(10) Pub. No.: US 2026/0169881 A1
(43) Pub. Date: Jun. 18, 2026

(54) APPLICATION MONITORING AND RECOVERY IN A DISTRIBUTED ENVIRONMENT

(71) Applicant: INTERNATIONAL BUSINESS MACHINES CORPORATION, Armonk, NY (US)

(72) Inventors: Carsten OTTE, Stuttgart (DE); Sonja KUNZE, Ehningen (DE); Oliver Guenther SCHLAG, Weil im Schoenbuch (DE); Muhammad Umair SALEEM, Milton (CA)

(21) Appl. No.: 18/978,249

(22) Filed: Dec. 12, 2024

(51) Int. Cl. G06F 11/30

(52) U.S. Cl. CPC G06F 11/302

(57) ABSTRACT

A computer-implemented method includes: subscribing to a kernel of an operating system running on a node in a distributed computing system; performing a discovery method that includes creating a watchlist that includes a set of processes running on the node; and performing a monitoring method that includes: receiving a process event notification from the kernel of the operating system; determining a process identified in the process event notification is on the watchlist; determining an event identified in the process event notification satisfies a rule associated with the process; and based on the process being on the watchlist and the event satisfying the rule, performing an action defined in the rule.

### BACKGROUND

Aspects of the present invention relate generally to computer application monitoring. Distributed computing systems may include a combination of technologies, such as virtual machines (VMs), containers, and native applications, to allow for the management and deployment of applications across multiple machines. Application monitoring in distributed computing systems may utilize parent/child process monitoring, front end service checking, and polling.

### SUMMARY

In a first aspect of the invention, there is a computer-implemented method including: subscribing to a kernel of an operating system running on a node in a distributed computing system; and performing a monitoring method that includes: receiving a process event notification from the kernel of the operating system; determining a process identified in the process event notification is on a watchlist; determining an event identified in the process event notification satisfies a rule associated with the process; and based on the process being on the watchlist and the event satisfying the rule, performing an action defined in the rule.

In another aspect of the invention, there is a computer program product comprising: one or more computer-readable storage media; and program instructions stored on the one or more computer-readable storage media. The program instructions perform operations comprising: subscribing to a kernel of an operating system running on a node in a distributed computing system, wherein the subscribing is performed using a netlink socket; and performing a monitoring method that includes: receiving a process event notification from the kernel of the operating system; determining a process identified in the process event notification is on a watchlist; determining an event identified in the process event notification satisfies a rule associated with the process; and based on the process being on the watchlist and the event satisfying the rule, performing an action defined in the rule.

In another aspect of the invention, there is a computer system comprising: a processor set; one or more computer-readable storage media; and program instructions stored on the one or more computer-readable storage media. The program instructions cause the processor set to perform operations comprising: subscribing to a kernel of an operating system running on a node in a distributed computing system, wherein the subscribing is performed using a netlink socket; and performing a monitoring method that includes: receiving a process event notification from the kernel of the operating system; determining a process identified in the process event notification is on a watchlist; determining an event identified in the process event notification satisfies a rule associated with the process; and based on the process being on the watchlist and the event satisfying the rule, performing an action defined in the rule.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows a flowchart of an exemplary method in accordance with aspects of the present invention.

FIG. 5 shows a flowchart of an exemplary method in accordance with aspects of the present invention.

### DETAILED DESCRIPTION

Aspects of the present invention relate generally to computer application monitoring. In accordance with aspects of the invention, a kernel connector monitor running on a node in a distributed computing system utilizes a netlink socket to receive process event information from an operating system of the node. In embodiments, the kernel connector monitor utilizes the process event information obtained from the operating system of the node to monitor process events associated with different applications (e.g., computer programs) running on the node. In this manner, the kernel connector monitor can be used to monitor plural applications running on a node and to perform actions in response to the occurrence of process events related to the applications. In one example, the kernel connector monitors the applications for process events that indicate an a termination of an application (e.g., the application has stopped running) and performs a predefined action based on a type of event associated with the termination.

In various implementations, processes can be filtered, including remote registration of processes to be monitored, or can be detected and monitored automatically on startup with optional rule-based filtering. A kernel connector monitor according to aspects of the present invention may be networked with one or multiple other nodes and may publish events about the state of monitored applications across a network. Operator consoles may be used in this network to allow operators to receive notifications from respective kernel connector monitors.

Implementations of the invention provide the capability to perform recovery actions immediately when an undesired situation is observed through the process events. Such recovery actions can either be specified based on process registration or may be applied automatically based on satisfying a predefined rule. The recovery actions may include, but are not limited to, restarting an application, notifying an administrator, and providing a message to an end user.

The technical field of computer application monitoring includes numerous different schemes, each of which has respective advantages and disadvantages. A first example of monitoring involves a parent process that monitors an immediate child process using parent/child based signaling. Examples of this first type of monitoring may use commands such as “podman” or “systemd” and may rely on operating system signals to detect failures immediately. However, this first type of monitoring suffers a drawback in that a parent process may only monitor its immediate child process and lacks the capability to monitor and detect failures in other processes that are not an immediate child process of the parent process. A second example of monitoring involves heartbeat-based monitors that utilize networking protocols such as Internet Control Message Protocol (ICMP) or Hypertext Transfer Protocol (HTTP). Examples of this second type of monitoring may include front-end service checking, such as loading pages from a web server on a regular basis, which may be used to detect a failure of an application when the front-end service of the application does not perform as expected. However, this second type of monitoring suffers from the drawback of there being a delay between occurrence of a failure of an application and detecting and understanding the failure. The technical field of computer application monitoring thus suffers from a lack of a monitoring scheme that can concurrently monitor plural different applications running in different environments on the same node and also immediately detect a failure in any of the plural different applications being monitored.

Implementations of the present invention provide a technical solution to the above-noted problems in the technical field of computer application monitoring by providing an application monitoring scheme that concurrently monitors plural different applications running in different environments on the same node and also is capable of immediately detecting a failure in any of the plural different applications being monitored. In embodiments, a kernel connector monitor runs on a node and uses a netlink socket to receive process event information from an operating system of the node. By obtaining process event information from the operating system of the node, the kernel connector monitor may concurrently monitor plural different applications running in different environments on the same node (e.g., applications running in one or more different containers, applications running one or more virtual machines, and/or one or more native applications being run by the operating system of the node), as opposed to parent/child monitoring that is limited to a parent process monitoring only its immediate child processes. Moreover, by performing the monitoring using process event information obtained directly from the operating system of the node, the kernel connector monitor can detect application failures immediately when they occur, as opposed to heartbeat-based monitoring that has an inherent delay between a failure of a back-end application and detecting the failure of the application via utilization of a front-end service. In this manner, implementations of the invention provide an improvement in the technical field of computer application monitoring.

Implementations of the invention are necessarily rooted in computer technology. For example, embodiments include a kernel connector monitor that accesses an operating system kernel of a computing node using a netlink socket. The netlink socket is a socket-based interface of an operating system kernel that provides two-way communication between the operating system (OS) kernel and user-space processes via a socket application programming interface (API). The netlink socket may also provide a kernel-side API for internal use by kernel modules. The socket itself, and the interface that the socket provides by which the kernel connector monitor accesses the operating system kernel, are inherently internal to a computer and cannot be performed in the human mind or with pen and paper.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as kernel connector monitoring code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

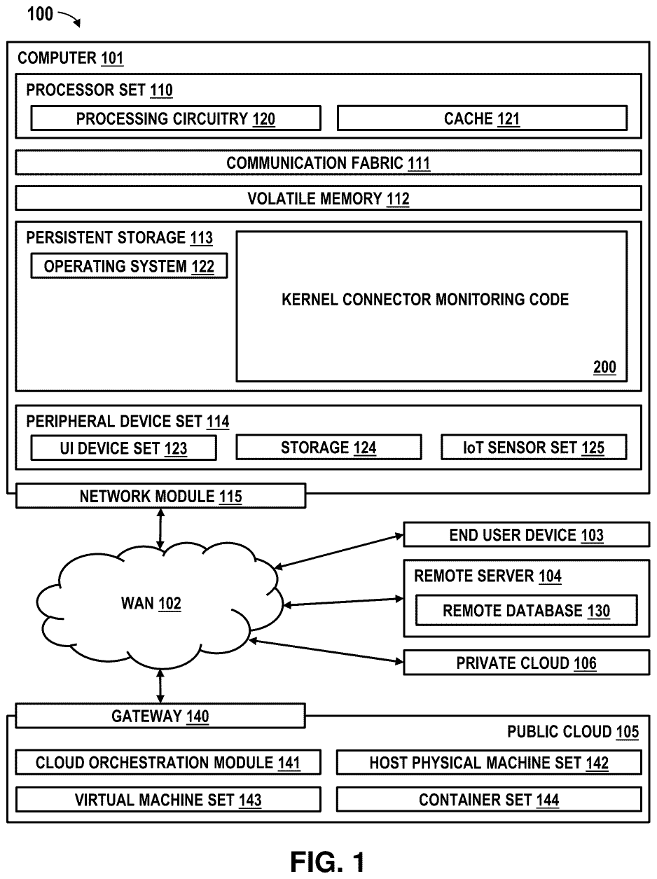

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

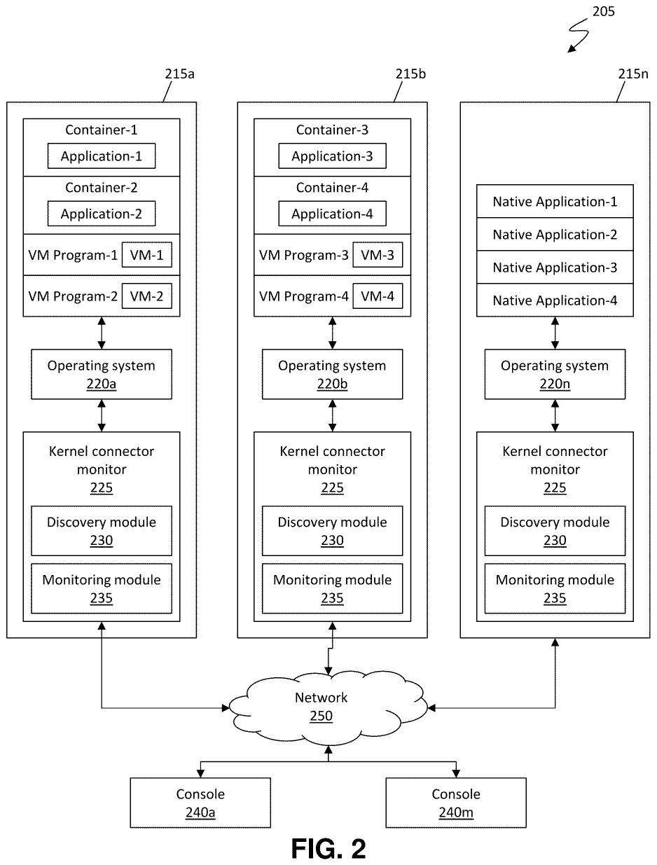

FIG. 2 shows a block diagram of an exemplary environment 205 in accordance with aspects of the invention. In embodiments, the environment 205 includes one or more nodes 215a, 215b, . . . , 215n, where “n” is any integer. Each of the nodes 215a-n comprises a computing device such as computer 101 of FIG. 1, for example. In embodiments, each of the nodes 215a-n includes a respective operating system 220a-n that manages hardware and software resources of the node and that provides services for computer programs running on the node. Such computer programs may include, but are not limited to, an application running in a container on the node, a virtual machine (VM) program that runs a VM on the node, and a native application running on the node. Different computer programs may run on different ones of the nodes 215a-n. For example, in the exemplary environment 205 shown in FIG. 2, node 215a runs computer programs including Application-1 running in Container-1, Application-2 running in Container-2, VM Program-1 that runs VM-1, and VM Program-2 that runs VM-2. With continued reference to the example shown in FIG. 2, node 215b runs computer programs including Application-3 running in Container-3, Application-4 running in Container-4, VM Program-3 that runs VM-3, and VM Program-4 that runs VM-4. Still referring to the example shown in FIG. 2, node 215n runs computer programs including Native Application-1, Native Application-2, Native Application-3, and Native Application-4. The examples shown in FIG. 2 are not limiting, and implementations of the invention may be used with any number of nodes 215a-n nodes running different arrangements of one or more applications running in one or more containers, one or more VM programs running one or more VMs, one or more native applications, or any combination of the foregoing. The VM Programs may comprise one or more different types of computer program that are configured to run a VM on the node, such as a Quick Emulator (QEMU) program or a Kernel-based Virtual Machine (KVM) program.

With continued reference to FIG. 2, in accordance with aspects of the invention, each of the nodes 215a-n includes an instance of a kernel connector monitor 225 that comprises the code of block 200 of FIG. 1 and is configured to perform processes described herein. In embodiments, the kernel connector monitor 225 comprises a discovery module 230 and a monitoring module 235, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The kernel connector monitor 225 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In various embodiments, each instance of the kernel connector monitor 225 is configured to communicate with one or more consoles 240 a, . . . , 240m via a network 250. Each of the consoles 240a-m may comprise an instance of an EUD 103 of FIG. 1, and there may be any integer number “m” of the consoles 240a-m. The network 250 may correspond to WAN 102 of FIG. 1.

In accordance with aspects of the invention, the discovery module 230 of the kernel connector monitor 225 is configured to perform a discovery method that identifies processes currently running on a respective one of the nodes 215a-n. In embodiments, after startup of the kernel connector monitor 225, the discovery module 230 subscribes to the kernel of the operating system of the node using a netlink socket. In embodiments, the netlink socket is a Linux kernel interface that: is available to “CAP_NET_ADMIN” privileged programs only; provides for receiving a broad range of events happening in the system; provides for receiving data across PID namespaces (e.g., containers); provides for informing about thread and thread group (e.g., process) creation; and provides for informing about thread and thread group (e.g., process) destruction, including information about exit codes, signals, and core dump information. In embodiments, the netlink socket provides a communication interface between the kernel connector monitor 225 and the kernel of a respective one of operating systems 220a-n, which may be referred to as an OS kernel. In embodiments, the netlink socket provides two-way communication between the OS kernel and user-space processes via socket APIs. In embodiments, the discovery module 230 uses one or more of these APIs to subscribe to the kernel of a respective one of operating systems 220a-n to obtain information from the respective one of operating systems 220a-n about processes being managed by the respective one of operating systems 220a-n and events associated with these processes. In embodiments, the discovery module 230 creates a watchlist that defines associations between processes, rules, and events in which a rule defines an action to perform when an event related to a process satisfies the rule.

In accordance with aspects of the invention, the monitoring module 235 is configured to perform a monitoring method of the kernel connector monitor 225. In embodiments, the monitoring module 235 receives process event information from the kernel of a respective one of operating systems 220a-n via the netlink socket based on the kernel connector monitor 225 being subscribed to the kernel of the respective one of operating systems 220a-n. In embodiments, the process event information is provided from the kernel of the respective one of operating systems 220a-n to the kernel connector monitor 225 in the form a process event notification. In embodiments, the monitoring module 235 determines from a process event notification whether a new process has been created in the respective one of operating systems 220a-n. When a new process is created, the monitoring module 235 determines whether the new process should be added to the watchlist that was created during the discovery method. In further embodiments, the monitoring module 235 determines from a process event notification whether an existing process associated with the process event notification is on the watchlist. When the existing process associated with the process event notification is on the watchlist, the monitoring module 235 determines whether the event satisfies a rule associated with this process. When the existing process associated with the process event notification is on the watchlist and the event satisfies the rule associated with this process, the monitoring module 235 performs an action defined by the rule. When the existing process associated with the process event notification is not on the watchlist, or when the event does not satisfy the rule associated with this process, the monitoring module 235 does not perform an action for this process event notification and waits for the next process event notification.

In embodiments, the rules are defined such that the monitoring module 235 monitors for process events that indicate the termination of a computer program running on the node. Such computer programs may include, but are not limited to, an application running in a container on the node, a virtual machine (VM) program that runs a VM on the node, and a native application running on the node. In embodiments, the process event notification received by the monitoring module 235 from the OS kernel includes information that defines a process and an event that has occurred in association with the process. In various embodiments, the information that defines the process comprises a process identifier (PID) associated with a process, and the information that defines the event includes one or more event codes such as exit codes, signals, and core dump information associated with termination of the process (also called process destruction). In one example, the rules are written in terms of the PID, an exit code, and action to be performed. For example, a first rule may state that if PID=“123” and exit code=“abc” then perform action “x”. A second rule may state that if PID=“123” and exit code=“def” then perform action “y”. In this example, the first and second rules are different rules that define different actions to be taken based on different exit codes associated with the same PID. In this manner, the different rules define different actions to perform when an application terminates depending on different ways of how the application terminated. Continuing this example, a third rule may state that if PID=“456” and exit code=“fgh” then perform action “z”. In this example, the third rule is associated with a different PID than the first and second rules, and the different PIDs may be associated with different ones of the computer programs running on the node. In this manner, the single kernel connector monitor 225 may be programmed with different rules for monitoring different ones of the computer programs running on the node.

The first, second, and third rules described above are illustrative examples, and a single kernel connector monitor 225 running on a node may have any number of rules defined for any desired number of processes, events, and actions. For example, the kernel connector monitor 225 running on the node 215a may have a first set of one or more rules defined in terms of a process associated with Application-1, a second set of one or more rules defined in terms of a process associated with Application-2, a third set of one or more rules defined in terms of a process associated with VM Program-1, and a fourth set of one or more rules defined in terms of a process associated with VM Program-2. Similarly, the kernel connector monitor 225 running on the node 215b may have a fifth set of one or more rules defined in terms of a process associated with Application-3, a sixth set of one or more rules defined in terms of a process associated with Application-4, a seventh set of one or more rules defined in terms of a process associated with VM Program-3, and an eighth set of one or more rules defined in terms of a process associated with VM Program-4. Similarly, the kernel connector monitor 225 running on the node 215n may have a ninth set of one or more rules defined in terms of a process associated with Native Application-1, a tenth set of one or more rules defined in terms of a process associated with Native Application-2, an eleventh set of one or more rules defined in terms of a process associated with Native Application-3, and a twelfth set of one or more rules defined in terms of a process associated with Native Application-4. Each of the sets of one or more rules may be different from one another.

The kernel connector monitor 225 in accordance with aspects of the invention may be used to concurrently monitor (i) one or more QEMU processes (or KVM processes) that run one or more VMs on a node, (ii) one or more applications running in one or more containers on the same node, and (iii) one or more native applications running on the same node. The kernel connector monitor 225 in accordance with aspects of the invention may be used to watch processes inside containers without changing them. The kernel connector monitor 225 in accordance with aspects of the invention may be used to act on failure events immediately. The kernel connector monitor 225 in accordance with aspects of the invention may be combined with other forms of monitoring including but not limited to parent/child process monitoring, heartbeat-based monitoring, and polling. The kernel connector monitor 225 in accordance with aspects of the invention may be configured to grow in usefulness along the ongoing extension of the kernel connector API. The kernel connector monitor 225 in accordance with aspects of the invention may provide monitoring and failure detection information to analytics and interactive visualization platforms, such as Grafana.

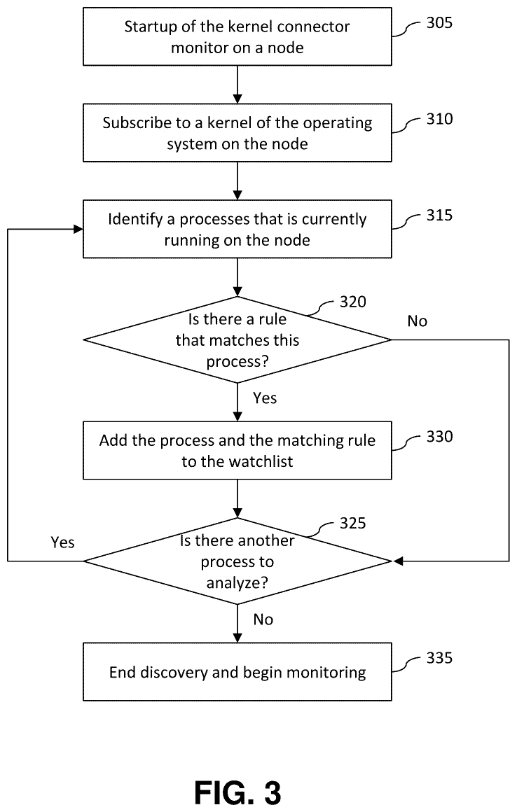

FIG. 3 shows a flowchart of an exemplary method in accordance with aspects of the present invention. Steps of the method (also referred to as operations) may be carried out in the environment of FIG. 2 and are described with reference to elements depicted in FIG. 2.

In embodiments, the method shown in FIG. 3 comprises a discovery method that an instance of the kernel connector monitor 225 runs once upon startup of the kernel connector monitor 225 on a node. In embodiments, the kernel connector monitor 225 performs the discovery method to create a watchlist of select ones of the processes running on the node at the time of startup of the kernel connector monitor 225. For illustration, FIG. 3 is described using the node 215a as an example.

At step 305, the kernel connector monitor 225 starts running on the node (e.g., node 215a). In embodiments, the operating system (e.g., operating system 220a) invokes a startup of the kernel connector monitor 225.

At step 310, the kernel connector monitor 225 subscribes to the kernel of the operating system 220a. In embodiments, and as described with respect to FIG. 2, the discovery module 230 subscribes to the kernel of the operating system 220a using a netlink socket. In particular, the discovery module 230 may subscribe to the kernel of the operating system 220a using an API exposed by the netlink socket, where the API is configured to publish process event information from the kernel of the operating system 220a to the kernel connector monitor 225.

At step 315, the kernel connector monitor 225 identifies a respective process running on the node 215a. In embodiments, the discovery module 230 determines all processes currently running on the node 215a using the “procps” command, which is a Linux command that gathers information about running processes via a process directory maintained by the operating system 220a. At step 315, the discovery module 230 identifies a respective one of these processes for analysis.

At step 320, the kernel connector monitor 225 determines whether a rule matches the respective process that was identified at step 315. In embodiments, and as described with respect to FIG. 2, the kernel connector monitor 225 stores or has access to plural rules that are defined in terms of process, event, and action. In embodiments, the discovery module 230 determines whether a rule matches the respective process by comparing the respective process to the processes defined in respective ones of the rules. The comparing may be based on a PID of the respective process matching a PID in one of the rules, for example.

At step 320, if the discovery module 230 determines there is not a rule that matches the respective process that was identified at step 315, then the method proceeds to step 325 where the discovery module 230 determines whether the respective process is the last process to analyze. In this branch of the method, the respective process that was identified at step 315 is not added to the watchlist because there is no rule that matches the respective process.

At step 320, if the discovery module 230 determines there is a rule that matches the respective process that was identified at step 315, then the method proceeds to step 330 where the discovery module 230 updates the watchlist by adding an entry that defines the respective process and the rule that matches the respective process.

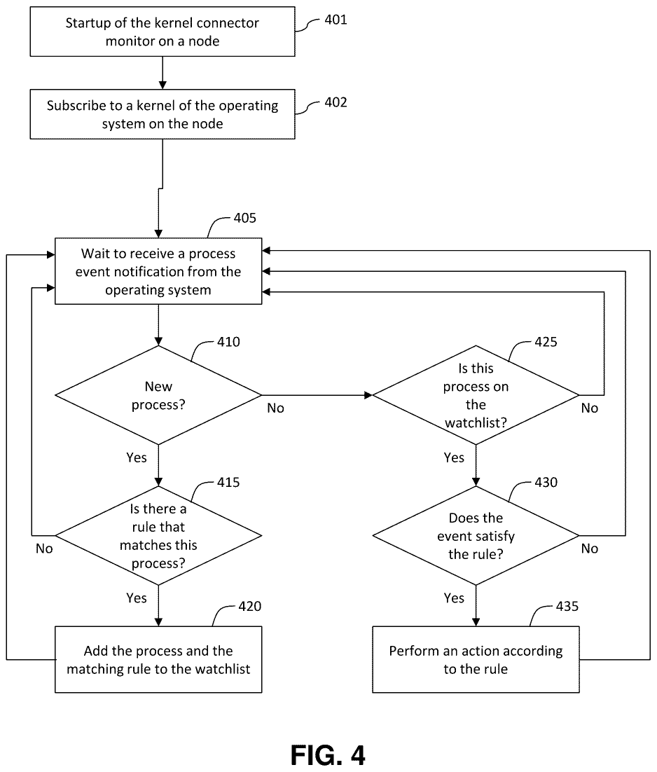

At step 325, the kernel connector monitor 225 determines whether the respective process from step 315 is the last process to analyze (i.e., to determine whether the process should be added to the watchlist). In embodiments, the discovery module 230 determines whether there are any currently running process (e.g., using the using the “procps” command) that have not yet been analyzed at step 320. If one or more processes have not yet been analyzed, then the discovery method returns to step 315 where a next one of the processes is identified. If all processes have been analyzed, then at step 335 the discovery method ends and a monitoring method (e.g., of FIG. 4) begins. In this manner, immediately after startup of the kernel connector monitor 225 on the node 215a, the discovery module 230 crawls through all the processes currently running on the node 215a and creates a watchlist that includes respective ones of the currently running processes that match one of the predefined rules.

FIG. 4 shows a flowchart of an exemplary method in accordance with aspects of the present invention. Steps of the method (also referred to as operations) may be carried out in the environment of FIG. 2 and are described with reference to elements depicted in FIG. 2.

In embodiments, the method shown in FIG. 4 comprises a monitoring method that an instance of the kernel connector monitor 225 performs in a loop after performing the discovery method of FIG. 3. In embodiments, the kernel connector monitor 225 performs the monitoring method using the watchlist that was created in the discovery method of FIG. 3. For illustration, FIG. 4 is described using the node 215a as an example.

At step 405, the kernel connector monitor 225 waits to receive a process event notification from the operating system 220a. In embodiments, and as described with respect to FIG. 2, the kernel connector monitor 225 is subscribed to the kernel of the operating system 220a using a netlink socket. Based on this subscribing, the kernel of the operating system 220a pushes process event notifications to the kernel connector monitor 225 in response to process related events occurring in the operating system 220a. At step 405, in response to the kernel connector monitor 225 receiving a process event notification from the operating system 220a, the method goes to step 410.

At step 410, in response to the kernel connector monitor 225 receiving a process event notification from the operating system 220a, the kernel connector monitor 225 determines whether the process identified in the process event notification is a new process (e.g., a process that was created after performing the discovery method of FIG. 3). In embodiments, the monitoring module 235 determines whether the process identified in the process event notification is a process that was identified and analyzed in the discovery method of FIG. 3. In embodiments, and as described with respect to FIG. 2, the process event notification received by the monitoring module 235 includes information that identifies a process running on the node 215a. In one example, the information that identifies the process comprises a PID associated with the process. In embodiments, at step 410 the monitoring module 235 compares the PID of the process identified in the process event notification to the PID of each process that was identified and analyzed in the discovery method of FIG. 3. A process that was identified and analyzed in the discovery method is not a new process. A process that was not identified and analyzed in the discovery method is a new process.

At step 410, if the process identified in the process event notification is a new process, then at step 415 the kernel connector monitor 225 determines whether there is a rule that matches the process identified in the process event notification. At step 415, if there is a rule that matches the process identified in the process event notification, then at step 420 the process and the matching rule are added to the watchlist. Steps 415 and 420 may be performed in a manner similar to steps 320 and 330, respectively, e.g., by comparing the PID of the process (in this case the process identified in the process event notification) to the PIDs in the predefined rules. Following step 420, the method returns to step 405 to wait for the next process event notification. At step 415, if there is not a rule that matches the process identified in the process event notification, then the kernel connector monitor 225 takes no further action for this process event notification and the method returns to step 405 to wait for the next process event notification.

At step 410, if the process identified in the process event notification is not a new process, then at step 425 the kernel connector monitor 225 determines whether the process identified in the process event notification is on the watchlist. In embodiments, the monitoring module 235 compares the PID of the process identified in the process event notification to the PIDs of processes included in respective entries in the watchlist. If the PID of the process identified in the process event notification matches the PID of one of the processes included in one of the entries in the watchlist, then the process identified in the process event notification is determined as being on the watchlist. If the PID of the process identified in the process event notification does not match the PID of one of the processes included in one of the entries in the watchlist, then the process identified in the process event notification is determined as not being on the watchlist.

At step 425, if the process identified in the process event notification is not on the watchlist, then the kernel connector monitor 225 takes no further action for this process event notification and the method returns to step 405 to wait for the next process event notification.

At step 425, if the process identified in the process event notification is on the watchlist, then at step 430 the kernel connector monitor 225 determines whether the event identified in the process event notification satisfies the rule associated with this process in the watchlist. In embodiments, and as described with respect to FIG. 2, the process event notification received by the monitoring module 235 includes information that identifies an event that has occurred in association with the process. In one example, the information that identifies the event includes event codes such as different exit codes that indicate different ways that a process may have stopped running on the node. In embodiments, at step 430 the monitoring module 235 compares the event code included in the process event notification to the event code in the rule associated with this process in the watchlist. If the event code included in the process event notification matches the event code in the rule associated with this process in the watchlist, then the event is determined to satisfy the rule. If the event code included in the process event notification does not match the event code in the rule associated with this process in the watchlist, then the event is determined to not satisfy the rule.

At step 430, if the event identified in the process event notification does not satisfy the rule associated with this process in the watchlist, then the kernel connector monitor 225 takes no further action for this process event notification and the method returns to step 405 to wait for the next process event notification.

At step 430, if the event identified in the process event notification satisfies the rule associated with this process in the watchlist, then at step 435 the kernel connector monitor 225 performs an action according to the rule. In embodiments, and as described at FIG. 2, each rule may define an action to be performed if an event satisfies the rule. For example, certain event codes may indicate that a process has terminated, which in turn indicates that an application running on the node has stopped running. Different rules may be tailored to cause different actions to be performed when an application shuts down in one of plural different manners. Examples of such actions include but are not limited to: sending a message to an end user device informing the end user that an application has stopped working; ignoring the application shutdown and taking no action; restarting the application in the same container; creating a new container and restarting the application in the new container; and sending a message to a troubleshooter and/or an administrator via a console 240a. In embodiments, the monitoring module 235 is configured to send appropriate instructions to one or more computing devices to carry out the action defined in the rule. In embodiments, after performing the action according to the rule, the method returns to step 405 to wait for the next process event notification.

In some embodiments, the discovery method of FIG. 3 is omitted, and the monitoring process of FIG. 4 builds the watchlist as new processes are found via process event notifications. In this implementation, the kernel connector monitor 225 starts running on the node (e.g., node 215a) at step 401, for example by the operating system (e.g., operating system 220a) invoking a startup of the kernel connector monitor 225. At step 402 the kernel connector monitor 225 subscribes to the kernel of the operating system 220a. In embodiments, the monitoring module 235 subscribes to the kernel of the operating system 220a using a netlink socket. In particular, the monitoring module 235 may subscribe to the kernel of the operating system 220a using an API exposed by the netlink socket, where the API is configured to publish process event information from the kernel of the operating system 220a to the kernel connector monitor 225. The kernel connector monitor 225 then waits for a next process event notification at step 405 and builds the watchlist from scratch by going through the monitoring method as already described.

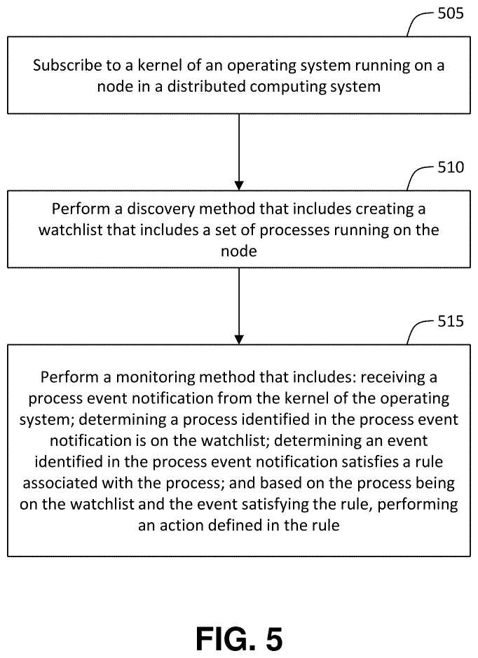

FIG. 5 shows a flowchart of an exemplary method in accordance with aspects of the present invention. Steps of the method (also referred to as operations) may be carried out in the environment of FIG. 2 and are described with reference to elements depicted in FIG. 2.

At step 505, the kernel connector monitor 225 subscribes to a kernel of an operating system (e.g., operating system 220a) running on a node (e.g., node 215a) in a distributed computing system. At step 510, the kernel connector monitor 225 performs a discovery method (e.g., as described at FIG. 3) that includes creating a watchlist that includes a set of processes running on the node. As noted above at FIG. 4, the discovery method is optional. At step 515, the kernel connector monitor 225 performs a monitoring method (e.g., as described at FIG. 4) that includes: receiving a process event notification from the kernel of the operating system; determining a process identified in the process event notification is on the watchlist; determining an event identified in the process event notification satisfies a rule associated with the process; and based on the process being on the watchlist and the event satisfying the rule, performing an action defined in the rule.

In embodiments of the method, the subscribing is performed using a netlink socket.

In embodiments of the method, the subscribing, the discovery method, and the monitoring method are performed by an instance of a kernel connector monitor running on the node.

In embodiments of the method, the set of processes running on the node include two or more selected from a group consisting of: a process associated with an application running in a container on the node; a process associated with a virtual machine program running a virtual machine on the node; and a process associated with a native application running on the node.

In embodiments of the method, the performing the monitoring method further includes: receiving a second process event notification from the kernel of the operating system; determining a second process identified in the second process event notification is on the watchlist; determining a second event identified in the process event notification does not satisfy a rule associated with the second process; and waiting for a next process event notification without performing an action in response to the second process event notification.

In embodiments of the method, the performing the monitoring method further includes: receiving a third process event notification from the kernel of the operating system; determining a third process identified in the third process event notification is not on the watchlist; and waiting for a next process event notification without performing an action in response to the third process event notification.

In embodiments of the method, the performing the monitoring method further includes: receiving a fourth process event notification from the kernel of the operating system; determining a fourth process identified in the fourth process event notification is a new process; determining the fourth process matches a predefined rule; updating the watchlist by adding the fourth process and the predefined rule to the watchlist; and waiting for a next process event notification.

In embodiments of the method, the performing the monitoring method further includes: receiving a fifth process event notification from the kernel of the operating system; determining a fifth process identified in the fifth process event notification is a new process; determining the fifth process does not match a predefined rule; and waiting for a next process event notification without performing an action in response to the fifth process event notification.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
subscribing to a kernel of an operating system running on a node in a distributed computing system; and
performing a monitoring method that includes:
receiving a process event notification from the kernel of the operating system;
determining a process identified in the process event notification is on a watchlist;
determining an event identified in the process event notification satisfies a rule associated with the process; and
based on the process being on the watchlist and the event satisfying the rule, performing an action defined in the rule.

2. The computer-implemented method of claim 1, wherein the subscribing is performed using a netlink socket.

3. The computer-implemented method of claim 1, further comprising performing a discovery method that includes creating the watchlist which includes a set of processes running on the node, wherein the subscribing, the discovery method, and the monitoring method are performed by an instance of a kernel connector monitor running on the node.

4. The computer-implemented method of claim 1, wherein the set of processes running on the node include two or more selected from a group consisting of:
a process associated with an application running in a container on the node;
a process associated with a virtual machine program running a virtual machine on the node; and
a process associated with a native application running on the node.

5. The computer-implemented method of claim 1, wherein the performing the monitoring method further includes:
receiving a second process event notification from the kernel of the operating system;
determining a second process identified in the second process event notification is on the watchlist;
determining a second event identified in the process event notification does not satisfy a rule associated with the second process; and
waiting for a next process event notification without performing an action in response to the second process event notification.

6. The computer-implemented method of claim 1, wherein the performing the monitoring method further includes:
receiving a third process event notification from the kernel of the operating system;
determining a third process identified in the third process event notification is not on the watchlist; and
waiting for a next process event notification without performing an action in response to the third process event notification.

7. The computer-implemented method of claim 1, wherein the performing the monitoring method further includes:
receiving a fourth process event notification from the kernel of the operating system;
determining a fourth process identified in the fourth process event notification is a new process;
determining the fourth process matches a predefined rule;
updating the watchlist by adding the fourth process and the predefined rule to the watchlist; and
waiting for a next process event notification.

8. The computer-implemented method of claim 1, wherein the performing the monitoring method further includes:
receiving a fifth process event notification from the kernel of the operating system;
determining a fifth process identified in the fifth process event notification is a new process;
determining the fifth process does not match a predefined rule; and
waiting for a next process event notification without performing an action in response to the fifth process event notification.

9. A computer program product comprising:
one or more computer-readable storage media; and
program instructions stored on the one or more computer-readable storage media to perform operations comprising:
subscribing to a kernel of an operating system running on a node in a distributed computing system, wherein the subscribing is performed using a netlink socket; and
performing a monitoring method that includes:
receiving a process event notification from the kernel of the operating system;
determining a process identified in the process event notification is on a watchlist;
determining an event identified in the process event notification satisfies a rule associated with the process; and
based on the process being on the watchlist and the event satisfying the rule, performing an action defined in the rule.

10. The computer program product of claim 9, wherein the operations further comprise performing a discovery method that includes creating the watchlist which includes a set of processes running on the node, and wherein the subscribing, the discovery method, and the monitoring method are performed by an instance of a kernel connector monitor running on the node.

11. The computer program product of claim 9, wherein the performing the monitoring method further includes:
receiving a second process event notification from the kernel of the operating system;
determining a second process identified in the second process event notification is on the watchlist;
determining a second event identified in the process event notification does not satisfy a rule associated with the second process; and
waiting for a next process event notification without performing an action in response to the second process event notification.

12. The computer program product of claim 9, wherein the performing the monitoring method further includes:
receiving a third process event notification from the kernel of the operating system;
determining a third process identified in the third process event notification is not on the watchlist; and
waiting for a next process event notification without performing an action in response to the third process event notification.

13. The computer program product of claim 9, wherein the performing the monitoring method further includes:
receiving a fourth process event notification from the kernel of the operating system;
determining a fourth process identified in the fourth process event notification is a new process;
determining the fourth process matches a predefined rule; and
updating the watchlist by adding the fourth process and the predefined rule to the watchlist; and
waiting for a next process event notification.

14. The computer program product of claim 9, wherein the performing the monitoring method further includes:
receiving a fifth process event notification from the kernel of the operating system;
determining a fifth process identified in the fifth process event notification is a new process;
determining the fifth process does not match a predefined rule; and
waiting for a next process event notification without performing an action in response to the fifth process event notification.

15. A computer system comprising:
a processor set;
one or more computer-readable storage media; and
program instructions stored on the one or more computer-readable storage media to cause the processor set to perform operations comprising:
subscribing to a kernel of an operating system running on a node in a distributed computing system, wherein the subscribing is performed using a netlink socket; and
performing a monitoring method that includes:
receiving a process event notification from the kernel of the operating system;
determining a process identified in the process event notification is on a watchlist;
determining an event identified in the process event notification satisfies a rule associated with the process; and
based on the process being on the watchlist and the event satisfying the rule, performing an action defined in the rule.

16. The computer system of claim 15, wherein the operations further comprise performing a discovery method that includes creating the watchlist which includes a set of processes running on the node, and wherein the subscribing and the discovery method are performed after startup of a kernel connector monitor running on the node and the monitoring method is performed after the discovery method.

17. The computer system of claim 15, wherein the performing the monitoring method further includes:
receiving a second process event notification from the kernel of the operating system;
determining a second process identified in the second process event notification is on the watchlist;
determining a second event identified in the process event notification does not satisfy a rule associated with the second process; and
waiting for a next process event notification without performing an action in response to the second process event notification.

18. The computer system of claim 15, wherein the performing the monitoring method further includes:
receiving a third process event notification from the kernel of the operating system;
determining a third process identified in the third process event notification is not on the watchlist; and
waiting for a next process event notification without performing an action in response to the third process event notification.

19. The computer system of claim 15, wherein the performing the monitoring method further includes:
receiving a fourth process event notification from the kernel of the operating system;
determining a fourth process identified in the fourth process event notification is a new process;
determining the fourth process matches a predefined rule; and
updating the watchlist by adding the fourth process and the predefined rule to the watchlist; and
waiting for a next process event notification.

20. The computer system of claim 15, wherein the performing the monitoring method further includes:
receiving a fifth process event notification from the kernel of the operating system;
determining a fifth process identified in the fifth process event notification is a new process;
determining the fifth process does not match a predefined rule; and
waiting for a next process event notification without performing an action in response to the fifth process event notification.
